(19) United States
(12) Patent Application Publication
(10) Pub. No.: US 2012/0125902 A1
(43) Pub. Date: May 24, 2012

(54) ABSORBING METHOD AND APPARATUS FOR REAR SIDE LASER PROCESS

(75) Inventors: Chun-Han Li, Tainan County (TW); Sung-Ho Liu, Kaohsiung City (TW); Min-Kai Lee, Tainan County (TW)

(73) Assignee: INDUSTRIAL TECHNOLOGY RESEARCH INSTITUTE, Hsin-Chu (TW)

(21) Appl. No.: 12/966,565

(22) Filed: Dec. 13, 2010

(30) Foreign Application Priority Data
Nov. 18, 2010 (CN) 099139677

(51) Int. Cl. B23K 26/00

(52) U.S. Cl. 219/121.72; 219/121.67

(57) ABSTRACT

An absorbing method and apparatus for rear side laser process is disclosed. A conductive plate contacts or separates above a flexible substrate which is deposited a conductive film therebelow. A power source electrically connects the conductive plate and the conductive film, or only the conductive plate. After the power source provides voltages, a Coulomb electrostatic force is produced between the conductive plate and the conductive film, so as to absorb the flexible substrate and the conductive film. A light source is disposed above the conductive plate and emits a laser beam which in series passes through the conductive plate and the flexible substrate, and then focuses on rear side of the conductive film to process. Therefore, it is able to avoid the flexible substrate bent or drooping, and improve yield rate.

### TECHNICAL FIELD

The present disclosure relates to a rear side laser process, and more particularly, to an absorbing method and apparatus for rear side laser process.

### TECHNICAL BACKGROUND

With rapid advance of rear side laser process, a debris-free processing can be achieved. Nevertheless, in order to cope with the demand for mass producing large-sized display panel with high resolution, it is intended to have a rear side process capable of achieving a line width that is the narrower the better. That is, the laser beam is focused for producing laser spot as small as possible. Consequently, since the smaller the laser spot is, the smaller the depth of focus (DOF) of the laser process will be, for preventing a processed film from not being laser etched completely or not even being laser-processed, it is important to use an absorbing platform for ensuring the flatness of the film to be maintained within a tolerance defined with respect to the DOF during the performing of a Roll-to-Roll (R2R) laser process.

However, for any conventional rear side laser process, especially when it is used for processing a flexible substrate, it is commonplace that the processed substrate is bending or even drooping during the laser process, causing not only the to the complexity and difficulty of laser process to increase, but also severely damaging precision of the laser process. Consequently, the processing time is prolonged and the yield of the laser process is decreased.

Therefore, it is in need of an improved method and apparatus of rear side laser process for overcoming the aforesaid shortcomings.

### TECHNICAL SUMMARY

The object of the present disclosure is to provide a method and apparatus for rear side laser process capable of absorbing a conductive film to the rear of a flexible substrate by the use of a Coulomb electrostatic force so as to prevent the flexible substrate from bending or drooping during the laser process, and thus enabling the conductive film to be laser-processed smoothly, causing the yield of the laser process to increase.

To achieve the above object, the present disclosure provides an absorbing apparatus for rear side laser process, comprising: a conductive plate, made of a transparent conductive material; a flexible substrate, disposed below the conductive plate in a manner selected from the group consisting of: it is disposed in contact with the conductive plate, and it is disposed separating from the conductive plate; a conductive film, being deposited on a bottom surface of the flexible substrate; a power source, having two ends electrically coupled to the conductive film and the conductive plate for inducing a Coulomb electrostatic force to be generated between the two; and a laser light source, disposed above the conductive plate, for emitting a laser beam to travel in series passing the conductive plate, the flexible substrate and then reaching the conductive film for processing the same.

Wherein the conductive plate is composed of a glass substrate and a transparent conductive layer in a manner that the transparent conductive layer is disposed on a top surface of the glass substrate while enabling a bottom surface of the glass substrate to be positioned proximate to the flexible substrate, and enabling one of the two ends of the power source that is provided for connecting to the conductive plate to be connected to the transparent conductive layer.

In an exemplary embodiment, the present disclosure provides an absorbing apparatus for rear side laser process, comprising: a conductive plate, made of transparent materials while being composed of a glass substrate and a transparent conductive layer in a manner that the transparent conductive layer is disposed on a top surface of glass substrate and is formed with an electrode structure with an anode and a cathode by a means selected from the group consisting of: etching and laser processing; a flexible substrate, disposed below the conductive plate in a manner selected from the group consisting of: it is disposed in contact with the conductive plate, and it is disposed separating from the conductive plate; a conductive film, being deposited on a bottom surface of the flexible substrate; a power source, electrically coupled to the electrode structure of the transparent conductive layer inducing a Coulomb electrostatic force to be generated between the conductive film and the conductive plate; and a laser light source, disposed above the conductive plate, for emitting a laser beam to travel in series passing the conductive plate, the flexible substrate and then reaching the conductive film for processing the same; wherein the transparent conductive layer of the conductive plate is disposed on a top surface of the glass substrate while enabling a bottom surface of the glass substrate to be positioned proximate to the flexible substrate.

In another exemplary embodiment, the present disclosure provides an absorbing method for rear side laser process, comprising the steps of: disposing a conductive plate above a flexible substrate in a manner selected from the group consisting of: disposing a conductive plate in contact with the flexible substrate and disposing a conductive plate separately from the flexible substrate while depositing a layer of conductive film on a bottom surface of the flexible substrate; electrically connecting two ends of a power source respectively to the conductive plate and the conductive film, or electrically connecting a power source to the conductive plate; enabling the power source to output a voltage so as to induce a Coulomb electrostatic force to be generated between the conductive film and the conductive plate so as to be used for absorbing the flexible substrate and the conductive film; and disposing a laser light source above the conductive plate for enabling a laser beam emitted therefrom to travel in series passing the conductive plate, the flexible substrate and then reaching the conductive film for processing the same.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A is a schematic diagram showing an absorbing apparatus for rear side laser process according to a first embodiment of the present disclosure as the power source thereof is not activated for outputting voltages.

FIG. 1B is a schematic diagram showing the absorbing apparatus for rear side laser process of FIG. 1A, but as the power source is being activated for outputting voltages.

FIG. 2A is a schematic diagram showing an absorbing apparatus for rear side laser process according to a second embodiment of the present disclosure as the power source thereof is not activated for outputting voltages.

FIG. 2B is a schematic diagram showing the absorbing apparatus for rear side laser process of FIG. 2A, but as the power source is being activated for outputting voltages.

FIG. 3 is a flow chart showing steps performed in an absorbing method for rear side laser process according to the present disclosure.

FIG. 4A is a graph profiling the relationship between the transmittance and wavelength of a laser beam that is projected onto the conductive plate of the present disclosure.

FIG. 4B is a graph profiling the relationship between the transmittance and wavelength of a laser beam that is projected onto the flexible substrate and the conductive film of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

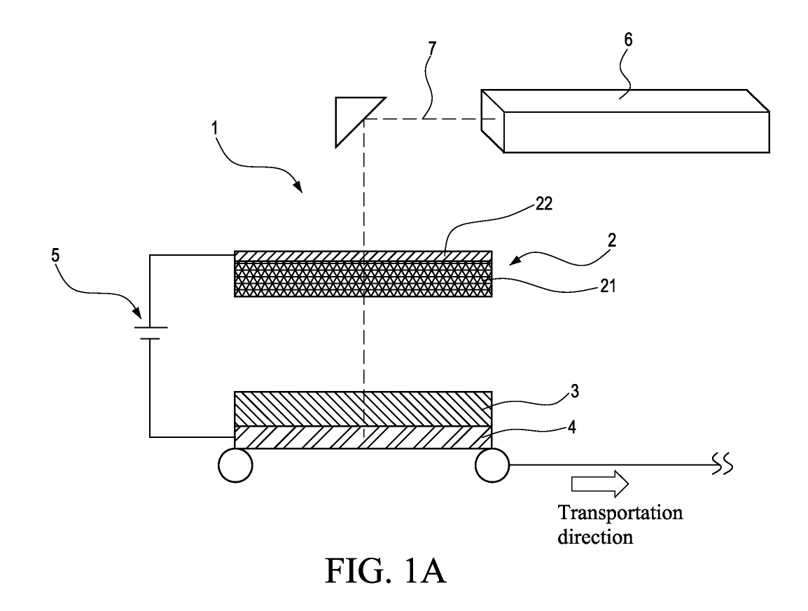

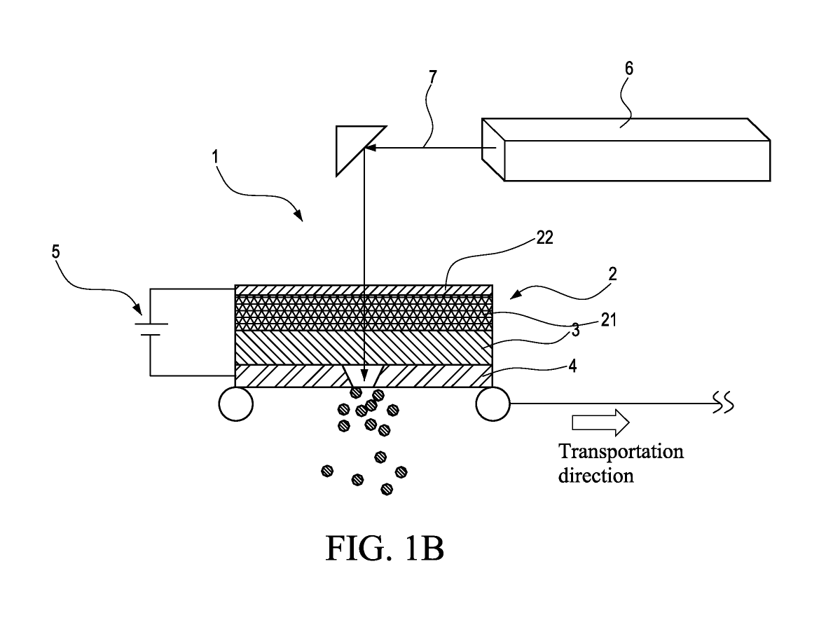

Please refer to FIG. 1A and FIG. 1B, which are a schematic diagram showing an absorbing apparatus for rear side laser process according to a first embodiment of the present disclosure as the power source thereof is not activated for outputting voltages, and a schematic diagram showing an absorbing apparatus for rear side laser process according to a first embodiment of the present disclosure as the power source thereof is activated for outputting voltages.

In this embodiment, the absorbing apparatus for rear side laser process 1 comprises: a conductive plate 2, a flexible substrate 3, a conductive film 4, a power source 5 and a laser light source 6.

The conductive plate 2, being made of transparent materials, is composed of a glass substrate 21 and a transparent conductive layer 22, in which the transparent conductive layer 22 can be made of indium tin oxide (ITO), aluminum zinc oxide (ZnAlO), zinc oxide (ZnO), or other transparent conductive oxides (TCOs), but is not limited thereby. Moreover, the transparent conductive layer 22 is disposed on a top surface of the glass substrate 21 while enabling the flexible substrate 3 to be disposed below the glass substrate 21, so as to enable one of the two ends of the power source 5 that is provided for connecting to the conductive plate 2 to be connected to the transparent conductive layer 22 while allowing another end to be connected to the conductive film 4.

The flexible substrate 3 is disposed under the conductive plate 2 and can be made of a transparent resin, such as the polyester (PET), but is not limited thereby. Moreover, the conductive film 4 can be made of a conductive material selected from the group consisting of: silver, gold, copper, and indium tin oxide (ITO), aluminum zinc oxide (ZnAlO), zinc oxide (ZnO), or other transparent conductive oxides (TCOs), but also is not limited thereby. As the conductive film is deposited on a bottom surface of the flexible substrate 3 and the two ends of the power source 5 are connected respectively to the conductive film 4 and the conductive plate 2, a Coulomb electrostatic force is induced to be generated between the conductive film 4 and the conductive plate 2 so as to absorb the conductive film 4 onto the conductive plate 2, and thus, by the absorption resulting from the Coulomb electrostatic force, any bending or drooping of the flexible substrate 3 during processing can be prevented.

The laser light source 6 is disposed above the conductive plate 2 that is used for emitting a laser beam 7 in a manner that the laser beam 7 is capable of travelling in series passing the conductive plate 2, the flexible substrate 3 and then reaching the conductive film 4 for processing the same, since the transmittance of the conductive plate 2 with respect to the laser beam 7 is larger than those of the flexible substrate 3 and the conductive film 4. The laser beam 7, appearing to be a defocus laser spot on the conductive plate 2 and the flexible substrate 3, is used to process the conductive film 4 disposed on the bottom surface of the flexible substrate 3, i.e. on the surface of the flexible substrate 3 that is opposite to the surface thereof facing toward the laser light source 6, so that the debris resulting from the process will fall directly downward by gravity without causing any adverse affect to the laser process.

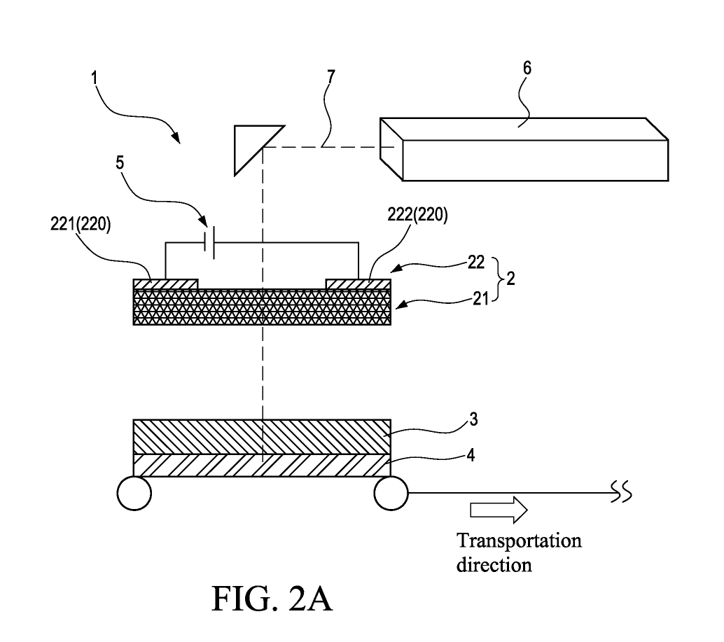

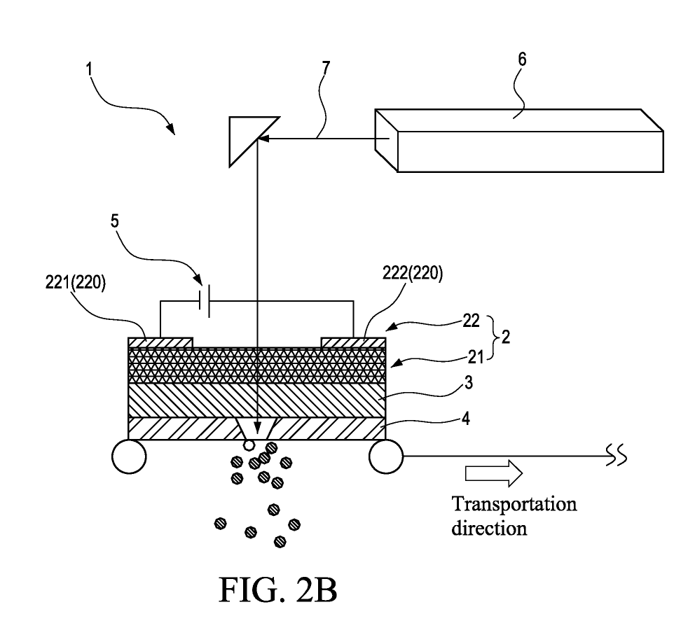

Please refer to FIG. 2A and FIG. 2B, which are a schematic diagram showing an absorbing apparatus for rear side laser process according to a second embodiment of the present disclosure as the power source thereof is not activated for outputting voltages; and a schematic diagram showing an absorbing apparatus for rear side laser process according to a second embodiment of the present disclosure as the power source thereof is activated for outputting voltages.

In this second embodiment, the absorbing apparatus for rear side laser process 1 comprises: a conductive plate 2, a flexible substrate 3, a film 4, a power source 5 and a laser light source 6.

Similarly, The conductive plate 2, being made of transparent materials, is composed of a glass substrate 21 and a transparent conductive layer 22, in which the transparent conductive layer 22 can be made of indium tin oxide (ITO), aluminum zinc oxide (ZnAlO), zinc oxide (ZnO), or other transparent conductive oxides (TCOs), but is not limited thereby. Moreover, the transparent conductive layer 22 is disposed on a top surface of glass substrate 21 while allowing the flexible substrate 3 to be disposed under the glass substrate 21, and is formed with an electrode structure 220 with an anode 221 and a cathode 222 by a means selected from the group consisting of: etching and laser processing.

The flexible substrate 3 is disposed under the conductive plate 2 and can be made of a transparent resin, such as the polyester (PET), but is not limited thereby. Moreover, the film 4 can be a material selected from the group consisting of: conductive material including silver, gold, copper, indium tin oxide (ITO), aluminum zinc oxide (ZnAlO), zinc oxide (ZnO), and other transparent conductive oxides (TCOs), and a non-conductive material including polymers, but also is not limited thereby. As the film 4 is deposited on a bottom surface of the flexible substrate 3 and the two ends of the power source 5 are connected respectively to the anode 221 and the cathode 222 of the electrode structure 220 formed on the transparent conductive layer 22, a Coulomb electrostatic force is induced to be generated between the film 4 and the conductive plate 2 so as to absorb the film 4 onto the conductive plate 2, and thus, by the absorption resulting from the Coulomb electrostatic force, any bending or drooping of the flexible substrate 3 during processing can be prevented. However, the absorbing force in this embodiment is a lateral force that it is smaller than the one from the first embodiment.

Similarly, the laser light source 6 is disposed above the conductive plate 2 that is used for emitting a laser beam 7 in a manner that the laser beam 7 is capable of travelling in series passing the conductive plate 2, the flexible substrate 3 and then reaching the conductive film 4 for processing the same, since the transmittance of the conductive plate 2 with respect to the laser beam 7 is larger than those of the flexible substrate 3 and the conductive film 4. The laser beam 7, appearing to be a defocus laser spot on the conductive plate 2 and the flexible substrate 3, is used to process the conductive film 4 disposed on the bottom surface of the flexible substrate 3, i.e. on the surface of the flexible substrate 3 that is opposite to the surface thereof facing toward the laser light source 6, so that the debris resulting from the process will fall directly downward by gravity without causing any adverse affect to the laser process.

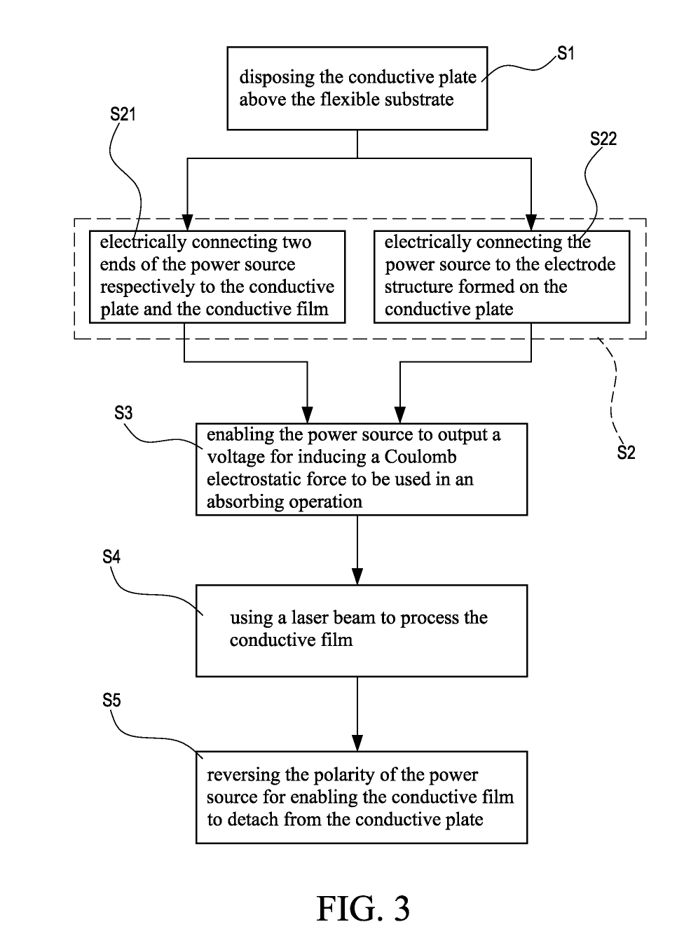

Please refer to FIG. 3, which is a flow chart showing steps performed in an absorbing method for rear side laser process according to the present disclosure. The aforesaid can be performed using the apparatuses disclosed in the first embodiment and the second embodiment, and is comprised of the following steps:
S1: disposing the conductive plate 2 above the flexible substrate 3 in a manner selected from the group consisting of: the conductive plate 2 is disposed in contact with the flexible substrate 3, and the conductive plate 2 is disposed separating from the flexible substrate 3, while depositing the conductive film 4 on the bottom surface of the flexible substrate;
S21: electrically connecting the two ends of the power source 5 respectively to the conductive plate 2 and the conductive film 4 when the apparatus of FIG. 1A is adopted;
S22: electrically connecting the two ends of the power source 5 to the anode 221 and the cathode 222 of the electrode structure 220 formed on the conductive plate 2 when the apparatus of FIG. 2A is adopted;
S3: enabling the power source 5 to output a voltage for inducing a Coulomb electrostatic force between the conductive plate 2 and the conductive film 4 for absorbing the conductive film 4 onto the flexible substrate 3; and
S4: disposing the laser light source 6 above the conductive plate for enabling the laser beam 7 emitted therefrom to travel in series passing the conductive plate 2, the flexible substrate 3 and then reaching and focusing on the conductive film 4 for processing the same.

It is noted that the wavelength of the laser beam 7 used in this disclosure is smaller than 100000 nm, whereas the laser beam 7 will appear to be a defocus laser spot on the conductive plate 2 and the flexible substrate 3. Moreover, after accomplishing the aforesaid steps, the method further comprise the following steps:
S5: reversing the polarity of the power source 5 for reversing the direction of the Coulomb electrostatic force being induced so as to enable the conductive film 4 to detach from the conductive plate 2 for facilitating the conductive film 4 along with the flexible substrate 3 to be sent to next processing stage, or stopping the voltage output of the power source 5 for stopping the Coulomb electrostatic force from being induced and thus enabling the conductive film 4 to detach from the conductive plate 2 for facilitating the conductive film 4 along with the flexible substrate 3 to be sent to next processing stage.

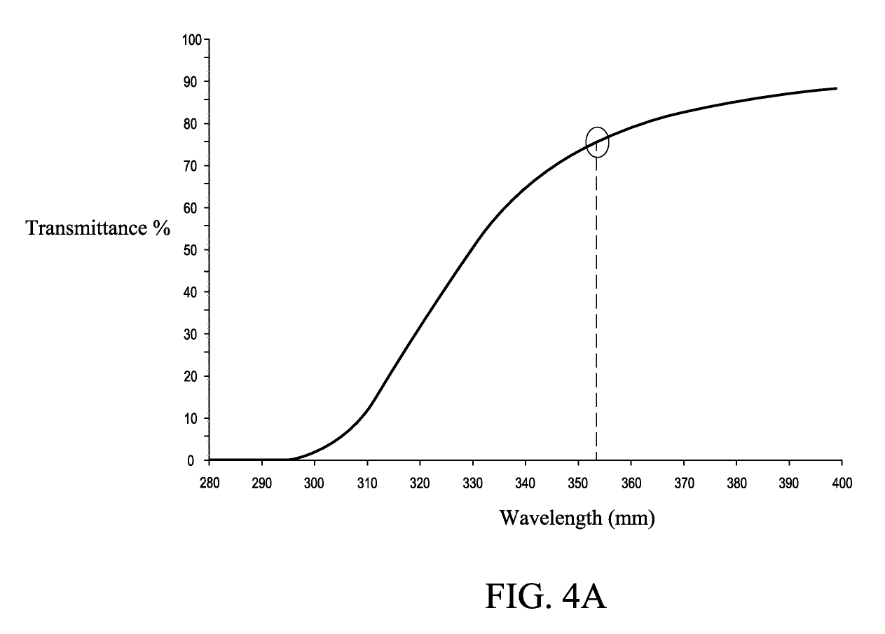

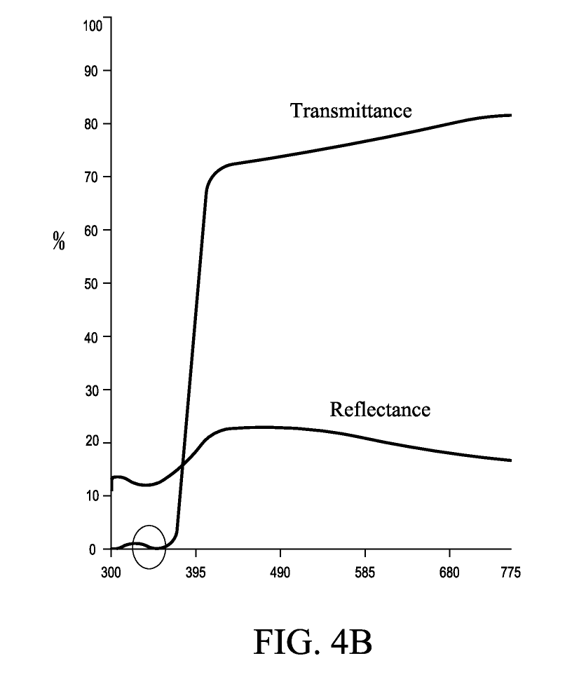

Please refer to FIG. 4A and FIG. 4B, which are a graph profiling the relationship between the transmittance and wavelength of a laser beam that is projected onto the conductive plate of the present disclosure, and a graph profiling the relationship between the transmittance and wavelength of a laser beam that is projected onto the flexible substrate and the conductive film of the present disclosure.

As shown in FIG. 4A, when the laser wavelength is about 355 nm, its transmittance with respect to the conductive plate 2 is larger than 70%. However, as shown in FIG. 4B, when the laser wavelength is about 355 nm, its transmittance with respect to the flexible substrate 3 and the conductive film 4 is smaller than 10%. Thereby, a laser beam 7 with a wavelength of 100000 nm is used for processing the conductive film 4 disposed at the bottom surface of the flexible substrate 3.

With the aforesaid apparatuses and method, after the power source 5 is enabled to output a voltage to the conductive plate 2 and the conductive film 4, or to the anode 221 and cathode 222 of the electrode structure 220 formed on the transparent conductive layer 22 of the conductive plate 2, a Coulomb electrostatic force will be induced between the conductive plate 2 and the conductive film 4 so as to be used for absorbing the conductive film 4 onto the flexible substrate 3, and thus, by the absorption resulting from the Coulomb electrostatic force, any bending or drooping of the flexible substrate 3 during processing can be prevented. Moreover, since the conductive film 4 is disposed on the bottom surface of the flexible substrate 3, i.e. on the surface of the flexible substrate 3 that is opposite to the surface thereof facing toward the laser light source 6, and the laser beam 7 emitted from the laser light source 6 will travel first passing the conductive plate 2 and the flexible substrate 3 before reaching the conductive film 4, the debris resulting from the process will fall directly downward by gravity without causing any adverse affect to the laser process, causing the yield of the laser process to increase.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An absorbing apparatus for rear side laser process, comprising:
a conductive plate, made of transparent conductive materials;
a flexible substrate, disposed below the conductive plate;
a conductive film, being deposited on a bottom surface of the flexible substrate; and
a power source, having two ends electrically coupled to the conductive film and the conductive plate for inducing a Coulomb electrostatic force to be generated between the two;

2. The absorbing apparatus for rear side laser process of claim 1, further comprising:
a laser light source, disposed above the conductive plate, for emitting a laser beam to travel in series passing the conductive plate, the flexible substrate and then reaching the conductive film for processing the same.

3. The absorbing apparatus for rear side laser process of claim 1, wherein the conductive plate is composed of a glass substrate and a transparent conductive layer; and the transparent conductive layer, being made of a transparent conductive material selected from the group consisting of: indium tin oxide (ITO), aluminum zinc oxide (ZnAlO), zinc oxide (ZnO), and other transparent conductive oxides (TCOs), is disposed on a top surface of the glass substrate while enabling the flexible substrate to be disposed below the glass substrate, so as to enable one of the two ends of the power source that is provided for connecting to the conductive plate to be connected to the transparent conductive layer while allowing another end to be connected to the conductive film.

4. The absorbing apparatus for rear side laser process of claim 1, wherein the conductive film is made of a conductive material selected from the group consisting of: silver, gold, copper, and indium tin oxide (ITO).

5. The absorbing apparatus for rear side laser process of claim 3, wherein the flexible substrate is made of a transparent resin composed of at least one polyester (PET).

6. The absorbing apparatus for rear side laser process of claim 1, wherein the wavelength of the laser beam is smaller than 100000 nm.

7. The absorbing apparatus for rear side laser process of claim 1, wherein the transmittance of the conductive plate with respect to the laser beam is larger than those of the flexible substrate and the conductive film.

8. An absorbing apparatus for rear side laser process, comprising:
a conductive plate, made of transparent materials while being composed of a glass substrate and a transparent conductive layer in a manner that the transparent conductive layer is disposed on a top surface of glass substrate and is formed with an electrode structure with an anode and a cathode by a means selected from the group consisting of: etching and laser processing;
a flexible substrate, disposed below the conductive plate;
a film, being deposited on a bottom surface of the flexible substrate; and
a power source, electrically connected to the electrode structure for inducing a Coulomb electrostatic force to be generated between the film and the conductive plate;
wherein, the transparent conductive layer is made of a transparent conductive material selected from the group consisting of: indium tin oxide (ITO), aluminum zinc oxide (ZnAlO), zinc oxide (ZnO), and other transparent conductive oxides (TCOs).

9. The absorbing apparatus for rear side laser process of claim 8, further comprising:
a laser light source, disposed above the conductive plate, for emitting a laser beam to travel in series passing the conductive plate, the flexible substrate and then reaching the conductive film for processing the same.

10. The absorbing apparatus for rear side laser process of claim 8, wherein the film is made of a material selected from the group consisting of: conductive material including silver, gold, copper, indium tin oxide (ITO), aluminum zinc oxide (ZnAlO), zinc oxide (ZnO), and other transparent conductive oxides (TCOs), and a non-conductive material including polymers.

11. The absorbing apparatus for rear side laser process of claim 8, wherein the flexible substrate is made of a transparent resin composed of at least one polyester (PET).

12. The absorbing apparatus for rear side laser process of claim 8, wherein the wavelength of the laser beam is smaller than 100000 nm.

13. The absorbing apparatus for rear side laser process of claim 8, wherein the transmittance of the conductive plate with respect to the laser beam is larger than those of the flexible substrate and the conductive film.

14. An absorbing method for rear side laser process, comprising the steps of:
disposing a conductive plate above a flexible substrate while depositing a layer of conductive film on a bottom surface of the flexible substrate;
selecting a connection form the group consisting of: electrically connecting two ends of a power source respectively to the conductive plate and the conductive film, and electrically connecting a power source to the conductive plate; and
enabling the power source to output a voltage so as to induce a Coulomb electrostatic force to be generated between the conductive film and the conductive plate so as to be used for absorbing the flexible substrate and the conductive film.

15. The absorbing method for rear side laser process of claim 14, further comprising the step of:
disposing a laser light source above the conductive plate for enabling a laser beam emitted therefrom to travel in series passing the conductive plate, the flexible substrate and then reaching the conductive film for processing the same.

16. The absorbing method for rear side laser process of claim 14, wherein in a condition that the two ends of the power source is connected respectively to the conductive plate and the conductive film and the conductive plate is composed of glass substrate and a transparent conductive layer, the transparent conductive layer is made of a transparent conductive material selected from the group consisting of: indium tin oxide (ITO), aluminum zinc oxide (ZnAlO), zinc oxide (ZnO), and other transparent conductive oxides (TCOs), and is disposed on a top surface of the glass substrate while enabling the flexible substrate to be disposed below the glass substrate, so as to enable one of the two ends of the power source that is provided for connecting to the conductive plate to be connected to the transparent conductive layer while allowing another end to be connected to the conductive film.

17. The absorbing method for rear side laser process of claim 14, wherein in a condition that the power source is electrically connected to the conductive plate and the conductive plate is composed of glass substrate and a transparent conductive layer and has an electrode structure formed thereon by a means selected from the group consisting of: etching and laser processing, the transparent conductive layer is disposed on a top surface of the glass substrate while allowing a bottom surface of the glass substrate to be disposed proximate to the flexible substrate, so as to enable the power source to connect electrically to the electrode structure of the transparent conductive layer.

18. The absorbing method for rear side laser process of claim 14, wherein the conductive film is made of a conductive material selected from the group consisting of: silver, gold, copper, indium tin oxide (ITO), aluminum zinc oxide (ZnAlO), zinc oxide (ZnO), and other transparent conductive oxides (TCOs).

19. The absorbing method for rear side laser process of claim 14, wherein the flexible substrate is made of a transparent resin composed of at least one polyester (PET).

20. The absorbing method for rear side laser process of claim 14, wherein the wavelength of the laser beam is smaller than 100000 nm.

21. The absorbing method for rear side laser process of claim 14, wherein the transmittance of the conductive plate with respect to the laser beam is larger than those of the flexible substrate and the conductive film.

22. The absorbing method for rear side laser process of claim 14, wherein after the laser beam travels in series passing the conductive plate, the flexible substrate and then reaches the conductive film for processing the same, the following step is proceeded:
selecting one procedure to be performed from the group consisting of:
reversing the polarity of the power source for reversing the direction of the Coulomb electrostatic force being induced so as to enable the conductive film to detach from the conductive plate; and stopping the voltage output of the power source for stopping the Coulomb electrostatic force from being induced and thus enabling the conductive film to detach from the conductive plate.
